(19) United States
(12) Patent Application Publication
(10) Pub. No.: US 2004/0227331 A1
(43) Pub. Date: Nov. 18, 2004

(54) Multi-functional wheelchair

(76) Inventors: Jia-Wine Chen, Taipen Hsien (TW); Bor-Shiou Guo, Taipei (TW)

Correspondence Address: Jia-Wine Chen, 235 Chung - Ho, Box 8-24, Taipei, TW

(21) Appl. No.: 10/636,950

(22) Filed: Aug. 6, 2003

(30) Foreign Application Priority Data
May 12, 2003 (TW) 092112859

(51) Int. Cl. A61G 5/00

(52) U.S. Cl. 280/650

(57) ABSTRACT

A wheelchair comprises a seat, a chair cushion covering on the seat, a footrest in front of the seat, a chair back at the back side of the seat, a back cushion covering on the chair back, two armrests at two sides of the seat, and two front wheels and two rear wheels below the seat. The height of the upper frame is adjustable by a push-and-brake device and the supporting frame. Another push-and-brake device is installed between the chair back and the footrest so that the chair back and the footrest can interact with one another. A seat and back cushion can move transversally and the back cushion can move longitudinally. An interior of the seat is hollowed so that stool can not be placed in the seat. Thereby, a multi-functional wheelchair is formed and the user has a larger space for action.

### FIELD OF THE INVENTION

The present invention relates to wheelchairs, and particularly to a multi-function wheelchair.

### BACKGROUND OF THE INVENTION

The prior art wheelchair has the following disadvantages:

The prior art wheelchair can not descend to a level equal to the height of a bed (about 45 centimeters). Thereby, the patients can not be horizontally moved from the wheelchair to the bed or from the bed to the wheelchair. Moreover, since the seat or armrests of a prior art wheelchair is higher than the table surface. Thereby, the chair back of the wheelchair is designed to be as lower as possible and the armrests is bendable for matching to the height of the table surface. Moreover, the wheelchair will be confined some mechanisms. For example, in the Taiwan Patent No. 459528 discloses a wheelchair. When the seat of the wheelchair rises, the armrests at two sides and footrest can not rise synchronously so that the gravitational center is risen so that the base of the wheelchair is unstable so that the wheelchair is possible to topple down.

In general, the chair back and the footrest can not be adjusted synchronously or is adjusted manually, such as those described in Taiwan Patent Nos. 444590, 481001, 331135. Thereby, the back and feet of the user can not move at the same time so that the gravitational center of the user is not at the center so that the body will slide. Furthermore, Taiwan Patent No. 444590, 481001 can not incline to a sufficient orientation. That is the chair back and the treadles of the footrest can not be horizontally arranged completely. Thus, the user can not lie horizontally. The burden at the lower portion of the body is increased.

In general, the center of the chair cushion has no movable sliding pad, and thus the user can not excrete on the wheelchair. The user must leave from the wheelchair for excretion. Taiwan Patent No. 328719 discloses a chair cushion which has a separable center sliding pad, but the chair cushion will disconnect with the seat. As re-assembly, the operation is troublesome. Moreover, the user possibly forgets to restore the chair cushion.

In the prior art wheelchair, the back cushion is fixed to a chair back. When the chair back changes its orientation, the back cushion will change the orientation with the orientation of the chair back so that the back of the user rubs the chair back. This is because as the chair back moves forward, a push force is applied to the user's back so the user is pushed forward to rub the back of the user (since the chair back is motionless). Likewise, when the chair back inclines downwards, the same condition occurs. This will induce bedsore to the patient.

The treadle of the footrest of a wheelchair is not telescopically. Thus the treadle can not descend to the ground. For the patient with breaking legs, this is a troublesome since the legs can not be moved easily the treadle. Two treadles are installed at left and right sides. If they can not be adjusted synchronously, this will make a trouble to the user.

Most of the wheelchair can not make the use to excrete on the wheelchair. Above said Taiwan Patent No. 328710 discloses a wheelchair which can be used with a stool, but no transversal rod is installed at the front and rear end of the lower side of the chair frame so that the wheelchair can not support a heavy object and thus the chair frame will deform as the user is heavy.

### SUMMARY OF THE INVENTION

Accordingly, the primary object of the present invention is to provide a wheelchair which comprising a seat 1, a chair cushion 2 covering on the seat 1, a footrest 3 in front of the seat 1, a chair back 4 at the back side of the seat 1, a back cushion 5 covering on the chair back 4, two armrests 6 at two sides of the seat 1, and two front wheels 14 and two rear wheels 15 below the seat 1.

The seat 1 is formed by an upper frame 11, a lower frame 12 and a supporting frame 13 installed between the upper frame 11 and the lower frame 12.

The upper frame 11 is formed by a left and a left bars 111, a front and a rear pivotal shafts 112, 113; and a sliding frame 114 being parallel to and below the bars 111 so as to long track groove is formed along the sliding frame 114.

The lower frame 12 has two primary rods 121; two secondary rods 122 telescopically moving in the respective primary rods 121 and a front transversal rod 123 connected between the two primary rods 121. Front ends of the primary rods 121 are connected to the front wheels and rear ends of the secondary rods 122 is connected to the rear wheels. Two push-and-brake device 16 is firmly secured to the lower frame 12. Each push-and-brake device 16 has a telescopic rod 161. One end portion of the telescopic rod 161 is combined to the secondary rods 122 of the lower frame 12.

Each supporting frame 13 includes two set of cross linkages; one set of the crossing linkage including one first push rod 131, one second push rod 132 and a pivotal shaft 133 for pivotally connecting the two push rods. A lower end of the first push rod 131 is pivotally connected to the secondary rod 122 by using a pivotal shaft 134 to connect the two; and the second push rod 132 being pivotally connected to the primary rod 121 by using a pivotal shaft 135 to combine the two so that the two push rods cross to one another. A top end of the first push rod 131, the upper frame bar 111 and the lateral frame 31 of the footrest 3 use the same pivotal shaft 112. A sliding rod 136 is transversally installed at the top of the first push rod 131 and is confined by the track groove of a sliding frame 114 of the upper frame bar 111.

Each of the armrest 6 is installed with a control device 8 so that when the telescopic rods 161 of the push-and-brake devices 16 telescopically move. The secondary rods in the primary rods 121 also telescopically moves so that the angle between the first linkage 131 and the second linkage 132 change; and thus the seat 1 rises or descends.

The various objects and advantages of the present invention will be more readily understood from the following detailed description when read in conjunction with the appended drawing.

### BRIEF DESCRIPTION OF THE DRAWINGS

FIG. 1 is a perspective view of wheelchair of the present invention.

FIG. 2 shows an exploded perspective view of the wheelchair of the present invention.

FIG. 3 shows the perspective view of the seat of wheelchair of the present invention.

FIG. 4 is a schematic view showing the rising operation of the upper frame of the seat according to the present invention.

FIG. 5 is a schematic view showing the descending operation of the upper frame of the seat according to the present invention.

FIG. 6 is a schematic view showing the connection of the footrest and the chair back of the present invention.

FIG. 7 is a schematic view showing the tilting operation of the footrest and the chair back of the wheelchair of the present invention.

FIG. 8 is a schematic view showing the standing operation of the footrest and the chair back of the present invention.

FIG. 9 is a perspective view showing the wheelchair of the present invention being in a lying position.

FIG. 10 is a schematic view showing the rotation operation of the armrests of the present invention.

FIG. 11 is a schematic view showing the separation of the back cushion and the chair cushion in the wheelchair of the present invention.

FIG. 12 is a schematic view showing the tilting operation of the chair back of the wheelchair of the present invention.

FIG. 13 is a schematic view showing the tilt operation of the prior art wheelchair.

FIG. 14 is a schematic view showing the tilting operation of the chair back of the present invention.

FIG. 15 is a schematic view showing another operation of separating the chair cushion and the back cushion according to the present invention.

FIG. 16 is an exploded perspective view of the chair back and the back cushion of the present invention.

FIG. 17 is an exploded perspective view showing the central sliding pads and the chair cushion of the present invention.

FIG. 18 is a schematic view showing the wheelchair and stool of the present invention.

FIG. 19 is a schematic view showing the operation of the chair cushion and the sliding pads of the present invention.

FIG. 20 is a lateral view of the second embodiment of the present invention.

FIG. 21 is a structural view showing the footrest in the third embodiment of the present invention.

### DETAILED DESCRIPTION OF THE PREFERRED EMBODIMENTS

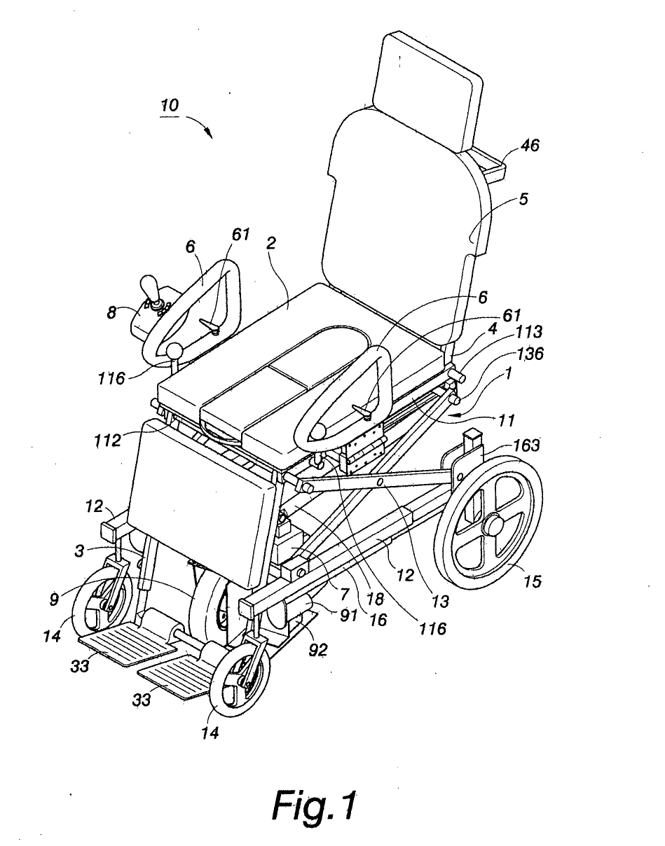

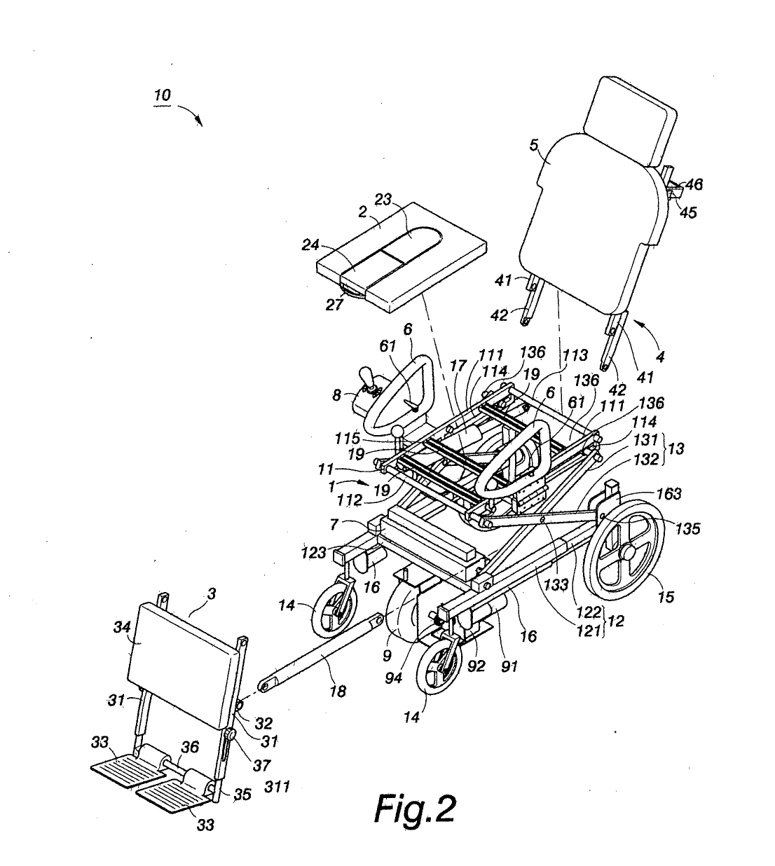

Referring to FIGS. 1 and 2, the perspective view and partial exploded perspective view of the present invention are illustrated. In these drawings, the wheelchair 10 includes a seat 1, a chair cushion 2 covering on the seat 1, a footrest 3 in front of the seat 1, a chair back 4 at the back side of the seat 1, a back cushion 5 covering on the chair back 4, two armrests 6 at two sides of the seat 1, and two front wheels 14 and two rear wheels 15 below the seat 1.

A later side of each armrest 6 is a control device 8 for controlling the following actions by only one hand: movement and turning of the wheelchair 10, lifting and descending of the seat 1; synchronous rotation and adjustment of the footrest 3 and the chair back 4. The power of the control device 8 is from the power supply system 7 at a front lower side of the seat 1. The power supply system 7 may be a chargeable battery. A single electric motive wheel 9 can be installed below the seat 1. A motor 91 serves to control the actions of moving forwards, backwards, turning leftwards or rightwards through the speed reduction gear box 92 and two gears 93 and 94 so that the patient can control the wheelchair 10 as desired. The driving structure and operation of the wheelchair 10 are known in the prior art and thus the details will not be description herein.

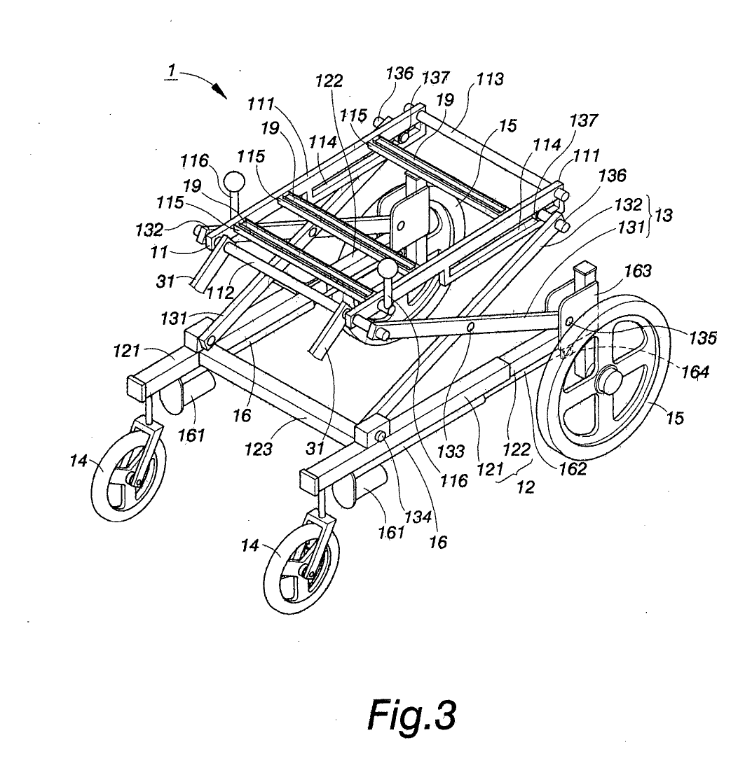

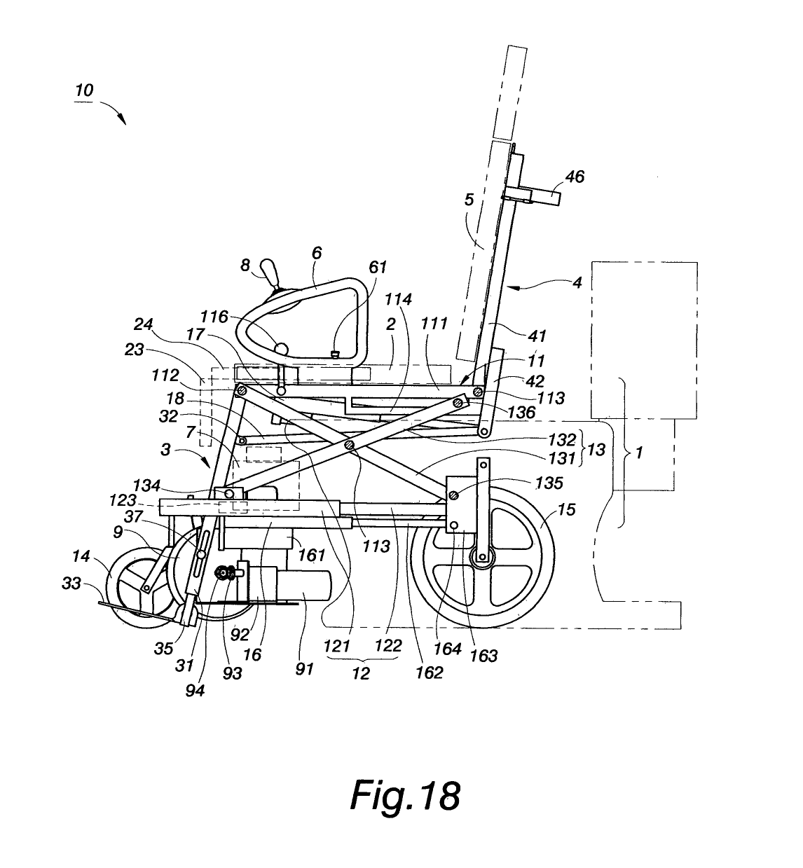

With reference to FIGS. 2 and 3, the perspective view of the seat of the wheelchair is illustrated. The seat 1 is formed by an upper frame 11, a lower frame 12 and two supporting frames 13 (having a crossing shape) between the upper frame 11 and lower frame 12. The upper frame 11 is formed by a left and a right bars 111 and a front and a rear pivotal shafts 112, 113. Moreover, a plurality of transversal rods 115 (in the drawings, threes transversal rods 115 are illustrated) can be used for enhancing the structure. A sliding frame 114 is connected and parallel to the bar 111. A long track groove is formed between the bar 111 and the sliding frame 114. The lower frame 12 is formed by a let and a right primary rods 121, two secondary rods 122 telescopically moving in the two primary rods 121. Front ends of the two primary rods 121 are combined with two front wheels 14 and rear ends of the two secondary rods 122 are combined with the two rear wheels 15. A transversal rod (not shown) can be used to connect the two secondary rods 122. However in this embodiment, no transversal rod is used to connect the two secondary rods 122. This is because once the transversal rod is installed, the wheelchair 10 can not be used to a stool. In other words, the stool can not be moved into the chair 1 of the wheelchair 10. Because no transversal rod is installed, the stool can be installed within the chair as the wheelchair 10 moves backwards, as shown in FIG. 18. Next, the two pivotal shafts 112, 113 serve to firmly secure the upper frame 11 and the front transversal rod 123 serves to firmly secure the lower frame 12, the structure is more stable and deformation can be prevented. Besides, two sets of supporting frames 13 are assembled at two sides of the upper frame 11 and lower frame 12. The structure of each supporting frame 13 is not confined, it is only necessary that the supporting frames 13 can be assembled to the upper frame 11 and lower frame 12.

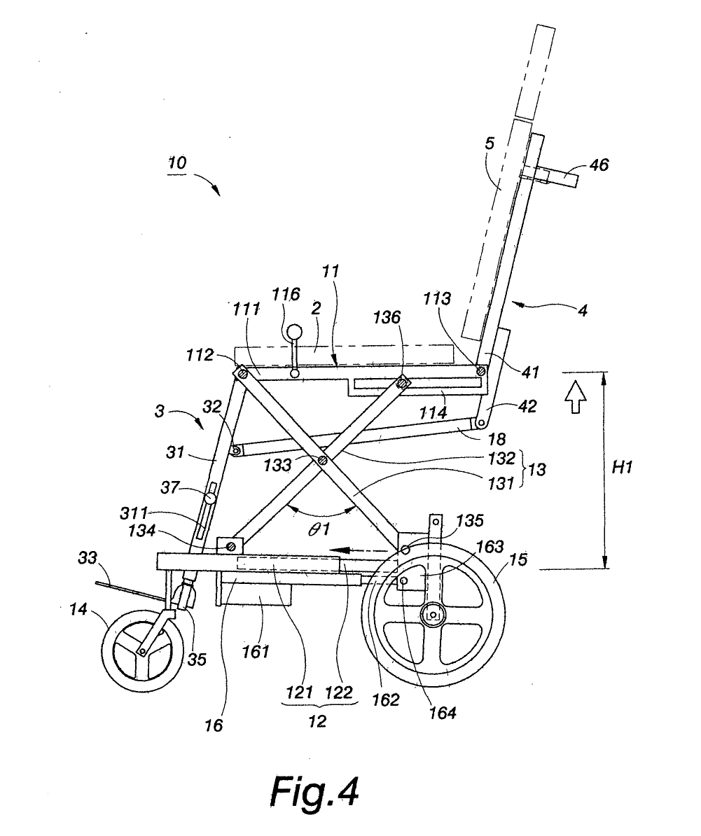

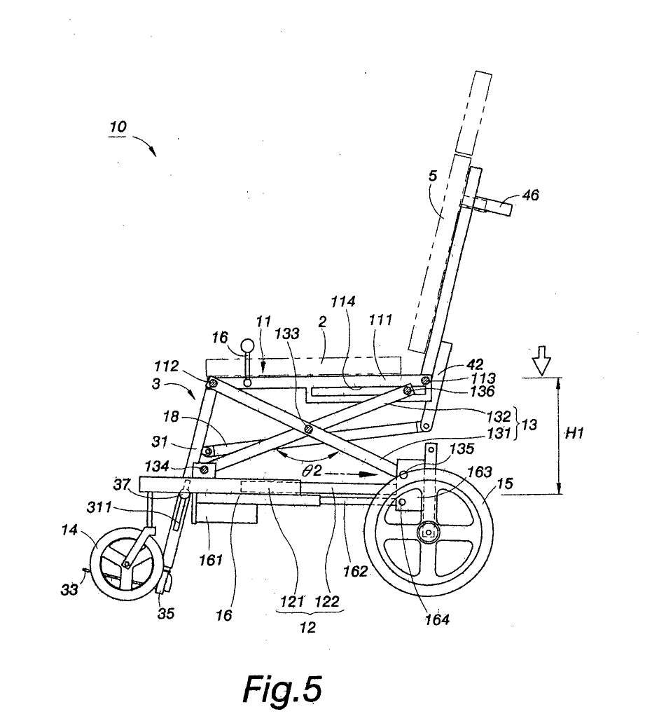

To make the upper frame 11 can be lifted or descended, in the following the supporting frames 13 are realized by crossing linkages. Each supporting frame 13 includes one first push rod 131, one second push rod 132 and a pivotal shaft 133 for pivotally connecting the two push rods 131, and 132. A lower end of the first push rod 131 is pivotally connected to a rear end of the secondary rod 122 by using a pivotal shaft 134 to connect the two; and the second push rod 132 is pivotally connected to the primary rod 121 by using a pivotal shaft 135 to combine the two so that the two push rods cross to one another. A top end of the first push rod 131, the upper frame bar 111 and the lateral frame 31 of the footrest use the same pivotal shaft 112. The sliding rod 136 transversally installed at the top of the first push rod 131 is confined by the track groove of a sliding frame 114 of the upper frame bar 111. The sliding rod 131 is slidable in the track groove. To make the movement of the sliding rod 136 easy, the sliding rod 136 can be combined with rollers 137. Besides, two push-and-brake devices 16 are firmly installed at the two sides of the lower frame 12. Each push-and-brake device 16 is driven by motor 161 and is speed-reduced by a speed reduction gear (not shown). Then a worm rod (i.e., the transversal rod 116) is driven by the worm gear (not shown) so that the push-and-brake device 16 can telescopically move. The structure of the push-and-brake device is known in the prior art and thus the details will not be further described here. Moreover, the brake can be performed by using air pressure cylinder with gears or rakes. Moreover, the structure of the push-and-brake device 16 is not confined by the structure shown in the drawings. Other structure can achieve the same object is also permissible in the present invention. All these are within the scope of the present invention. The end portion of the telescopic rod 162 is combined to the lower frame secondary rod 122 (in the drawing, it is fixed by a pivotal shaft 164). Therefore to be arranged easily, a connecting block 163 can be used to combine the telescopic rod 162, the secondary rod 122 and the first push rod 131. By the telescopic movement of the telescopic rod 162 of the push-and-brake device 16, the lower frame secondary rod 122 can be synchronously driven to move forwards or backwards so that the angle between the two push rods 131, 132 of the supporting frames 13 is changed. Thus, the pivotal shaft 112, and the sliding rod 136 will lift the upper frame 11 to change the elevation of the upper frame 11, as shown in FIGS. 4 and 5.

With reference to FIG. 4, a schematic view showing the rising operation fo the seat upper frame 11. When the telescopic rod 162 of the push-and-brake device 16 reduced inwards, the lower frame secondary rod 122 moves inwards. Then the first push rod 131 is driven by the secondary rod 122 so as to be affected, and thus the angle between the two push rods are changed. That is to say the angle θ 1 between the two push rods 131, 132 are reduced gradually. Moreover, the height H1 of the cross form supporting frame 13 is increased gradually. Moreover, since the sliding rod 136 at the top end of the second push rod 132 is confined in the sliding groove of the upper frame sliding frame 114, at the time that the first and second 131, 132 are driven, the pivotal shaft 112 and the sliding rod 136 will enforce the upper frame 11 to rise stably. As a result, the height of the seat 1 is increased.

Furthermore, as shown in FIG. 5, a schematic view showing the descending operation of the seat upper frame 11. When the telescopic rod 162 of the push-and-brake device 16 protrudes out, the lower frame secondary rod 122 moves outwards. Then the first push rod 131 is driven by the secondary rod 122 so that the angle between the first and second push rods 131, 132 are interconnected. Then the angle θ 2 increases gradually, but the height of the supporting frame 13 H2 will reduce gradually. Furthermore, when the two push rods 131, 132 are interconnected, the pivotal shaft 112 and the sliding rod 136 will drive the upper frame 11 to descend stably. Thus, the height of the seat 1 is reduced. By the rising and descending of the seat upper frame 11, the patient sitting on the wheelchair 10 can take objects at a higher place or a lower place. Thereby, it is adjustable with the height of the table. Moreover, the wheelchair can move horizontally with respect to a bed.

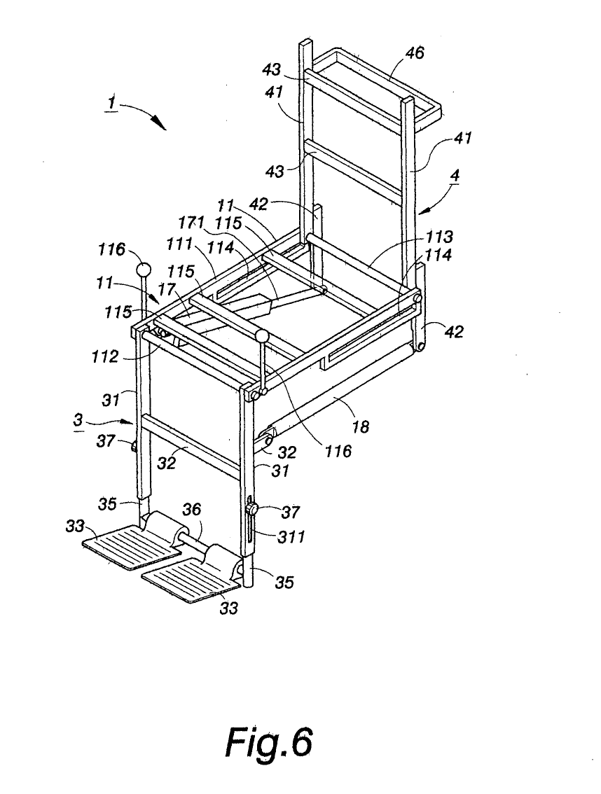

With reference to FIG. 6, the driving mechanism between the footrest 3 and the chair back 4 is illustrated. In the drawing, it is illustrated that the footrest 3 is formed by two lateral rods 31 two upper transversal rods 32 connected to the two lateral rods 31, two secondary rods 35 installed in the two secondary rods 35, two lower transversal rods 36 connected to the two secondary rods 35, two positioning screws 37 for fixing the secondary rods 35, and two treadles 33 installed below the secondary rods 35. A foot pad 34 is installed between the two lateral rods 31 for supporting the feet. The tops of the two lateral rods 31, the upper frame bar 111, the first push rod 131 (not shown) use the same pivotal shaft. A lower end of each of the two lateral rods 31 is formed with a long hole 311 for receiving a positioning screw 37. Then the positioning screw 37 is further screwed into the secondary rod 35 so that the lateral rod 31 is combined with the secondary rod 35. When the positioning screws 37 are released, the height of the two secondary rods 35 are adjustable at the same time. After a height is achieved, the positioning screws 37 are fixed. Thereby, the treadles 33 can descend to ground so that the legs of a patient can move horizontally, and moreover, when the patient changes pose from sitting to lie on the wheelchair, the feet of the patient can extend straightly.

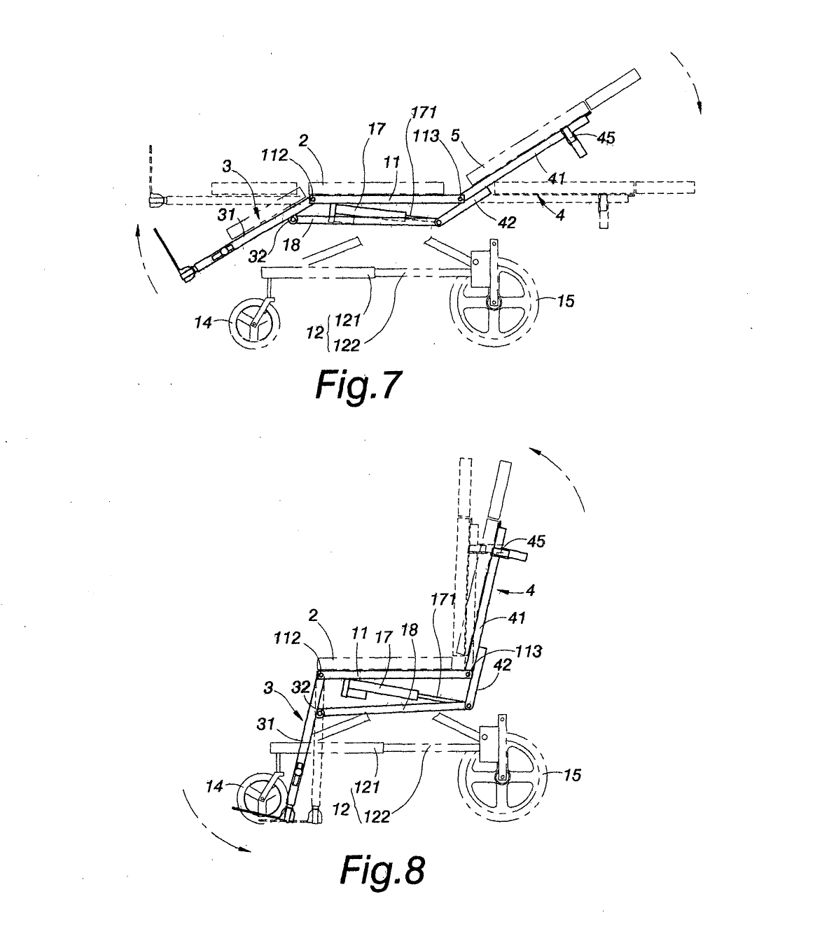

Next, the chair back 4 is formed by a left and a right lateral rods 41, and a plurality of transversal rods 43. A handle 46 is installed between the two lateral rods 41 for being held by medical persons. A lower end of each lateral rod 41 and the upper frame bar 111 use the same pivotal shaft 113. A bottom of each lateral rod 41 extends with a supporting rod 42. The supporting rod 42 is an extending rod of the lateral rod 41. One supporting rod 42 (shown on the drawing) is connected to an end portion of one telescopic rod 171 of a push-and-brake device 17. A rear end of the push-and-brake device 17 is fixed below the upper frame 11 (it is preferably below the bar 111). The push-and-brake device 17 is the same as the push-and-brake device 16. Thus, the push-and-brake device 17 can be realized by other mechanism having the same function. Besides, another supporting rod 42 (at a lower place of the drawing) is pivotally connected to one end of a linkage 18. Another end of the linkage 18 is pivotally connected to the footrest lateral rod 31. To drive easily, a further supporting rod 32 can be added to the lateral rod 31 for connecting the linkage 18. Since the push-and-brake device 17 is inclined, the chair back 4 will incline with the telescopic rod 171 telescopically moves. Thereby, the footrest 3 and the chair back 4 moves synchronously for adjusting the orientation. The connection will be understand with reference to FIGS. 7 and 8.

Referring to FIG. 7, the process about the driving operation of the footrest 3 and the chair back 4 is illustrated. From above description, it is known that the upper frame 11, footrest 3 and the chair back 4 are pivotally connected. When the telescopic rod telescopically moves, the chair back 4 will move backwards along the pivotal shaft 113. Since the chair back 4 synchronously drives the footrest 3 by the linkage 18 so that the footrest 3 moves upwards along the pivotal shaft 112 until the footrest 3, chair back 4 and the upper frame 11 are horizontal. Finally, by a security switch (not shown, it can be for example an extreme switch) to turn off the push-and-brake device 17, the power is turned off.

Furthermore, as shown in FIG. 8, the extension of the telescopic rod 171 of the push-and-brake device 17 will interact the chair back 4 so that the chair back 4 lifts upwards along the pivotal shaft 113. Then the chair back 4 drives the linkage 18 to drive the footrest 3 so that the footrest 3 descends along the pivotal shaft 112 until the footrest 3 and the chair back 4 is vertical. Finally, the security switch (not shown) turns off power of the push-and-brake device 17 for stopping the operation. Thus, it is appreciated that the control device 8 can control the orientations of the footrest 3 and the chair back 4 as required.

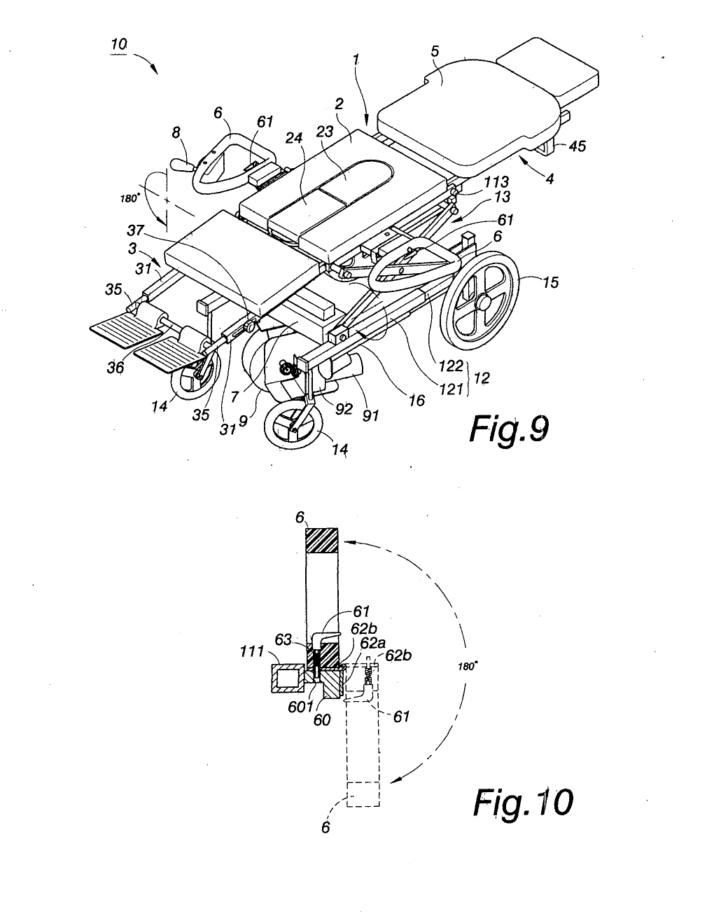

Referring to FIG. 9, a schematic view showing the operation of the footrest 3 and the chair back 4 which causes the wheelchair to be as a lying chair so that a patient can lie on the lying chair and the length of the treadle 33 is adjustable. Two sides of the seat 1 are installed with armrests 6. The armrests 6 are fixed to the sides of the upper frame bars 111, as shown in FIG. 10. A side of the upper frame bar 111 is fixed to the base 60. The base 60 is fixed to one side of a hinge 62a and another side of the hinge 62a is combined to the armrest 6. Each armrest 6 is installed with a positioning stud 61. The positioning stud 61 is serially disposed with a spring 63. When the armrest 6 stands, the positioning stud 61 will insert into a positioning hole 601 of the base 60 by the resilient force of the spring 63. On the contrary, when the positioning stud 61 is pulled upwards, it will separate from the positioning hole 601 so that the armrest 6 rotates through 180 degrees toward the lateral side. Since the structure and principle of the armrests 6 are well known in the prior art and they are no the feature of the present invention, the details will not be described here.

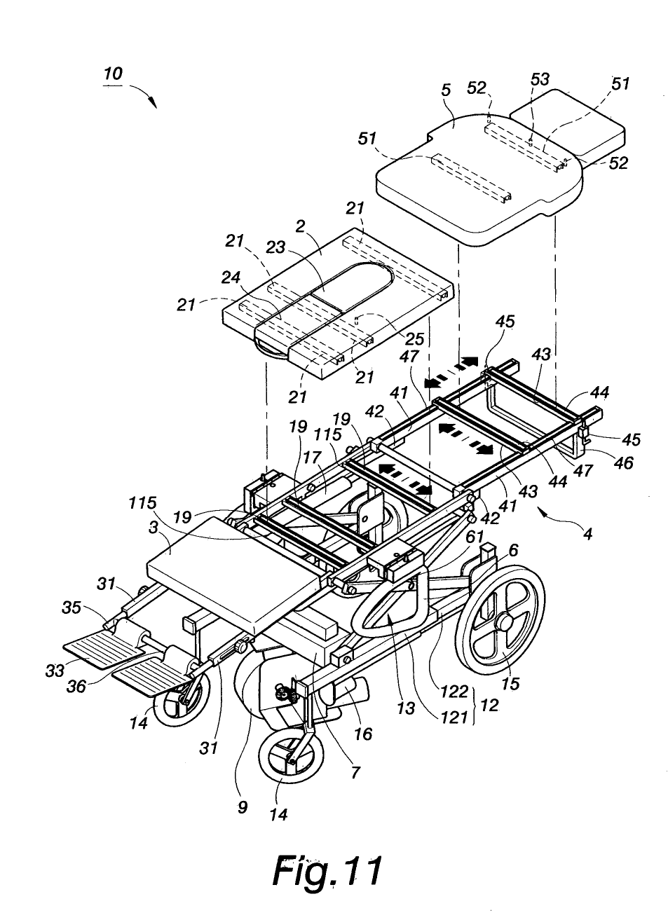

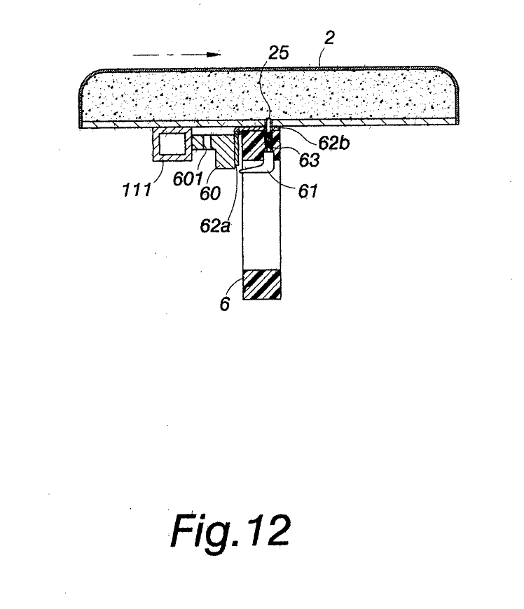

With reference to FIG. 11, the exploded perspective view of the chair cushion 2 and the back cushion 5 of the wheelchair 10 are illustrated. There transversal rods 115 of the upper frame 11 of the seat 1 are installed with sliding tracks 119, respectively. A bottom of the chair cushion 2 is installed with three cushion tracks 21 (or other sliding elements) corresponding to the sliding tracks 19. When the armrests 6 are released from being positioned, they will swing downwards, then the cross strip moves outwards and horizontally. In other words, the armrests 6 will not stop of the chair cushion 2, the chair cushion 2 can move transversally by the matching of the connecting track 21 and the sliding track 19. After the chair cushion 2 moves out, the positioning studs 61 of the armrests 6 insert into the positioning holes 25 of a bottom plate of the chair cushion 2, as shown in FIG. 12 so as to achieve the object of positioning. Besides, an elastic positioning stud (not shown) below the bar 111 serves for positioning the chair cushion 2.

Next, the transversal rods 43 of the chair back 4 have sliding tracks 44, respectively; and a bottom of the back cushion 5 is installed with connecting tracks 51 corresponding to the sliding tracks 44. Besides, lateral sides of the lateral rods or push frame 46 is installed with an elastic positioning stud 45. A bottom of the back cushion 5 is formed with insertion holes 52 for being inserted by the positioning studs 45. The positioning studs 45 can be inserted into the insertion holes 52 by the expansion of the springs, and thus generally, the back cushion 5 is positioned on the chair back 4. When the positioning studs 45 are pulled out from the insertion holes 52 manually, the back cushion 5 can be moved transversally by the matching of the connecting tracks 51 and the sliding tracks 44. After moving transversally, the positioning studs 45 are inserted into the positioning holes 53 for positioning. By the transversal movement, the patient can be moved to a bed from the wheelchair 10, and vice versa. Since the chair cushion 2 and back cushion 5 like sliding boards, the patient need not use any auxiliary tools. Thus, the patient will not ache in the wound or due to bedsore.

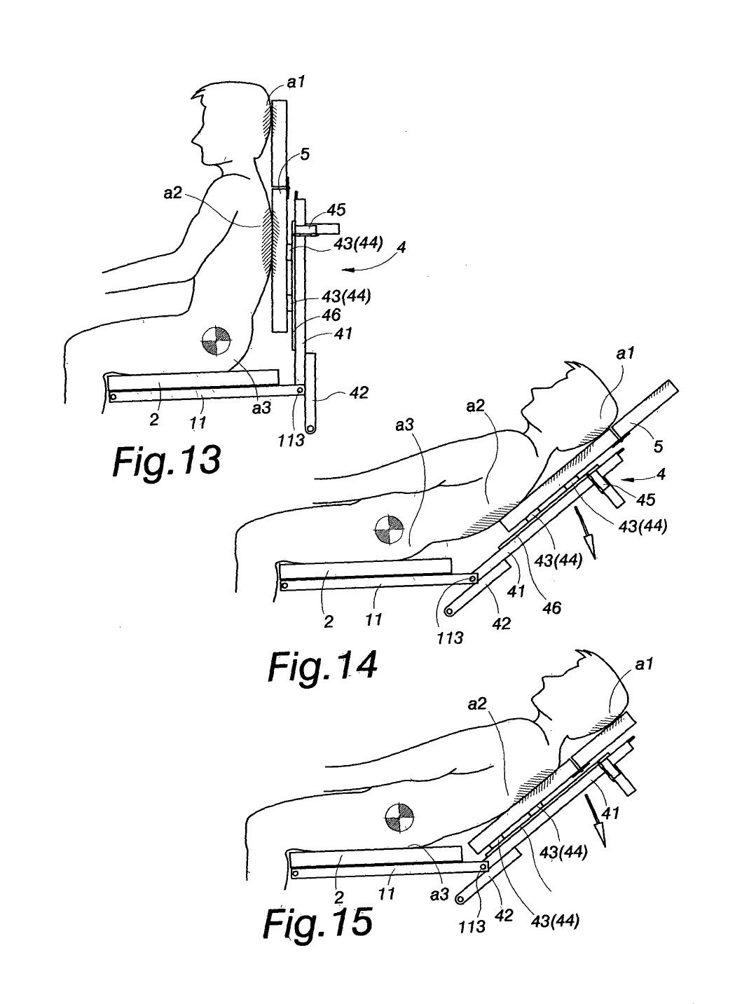

Further, when the wheelchair 10 is changed into a lying chair from the seat (referring to FIG. 9) or into a seat from a lying chair (referring to FIG. 1), in the interaction of the footrest 3 and the back cushion 5, the back of the patient will rub the back cushion 5 so that the bedsore in the back or the wound will fell ache. This can be understand from those shown in FIGS. 13 and 14.

Referring to FIG. 13, when the back cushion 5 stands, the head al, back a2 and bottom 3a of a human will contact the back cushion 5. When the gravitational center of the body is at the bottom 3a and the back cushion 5 pivotally rotates backwards, as shown in FIG. 14, the head al, back a2 will incline backwards and the bottom 3a will not change. The back a2, bottom a3 and the pivotal shaft 113 are formed as a triangle. Since rotation of the back a2 is at a position near the bottom a3, and the rotation shaft of the back cushion 5 is the pivotal shaft 113, the back cushion 5 fixed to the chair back 4 will rub the back 2a as the chair back 4 rotates. Further, when the patient changes the pose from lying to sit, the normal force from lifting the chair back 4 is not the same as the normal force of the human bock a2, the human body will push forward so that the bottom 3a slides forward slightly.

To solve above said problem, it is only necessary to longitudinally slide the back cushion 5, as shown in FIG. 15. In rotating the chair back 4, the back cushion 5 will slide downwards due to contact with the back a2. That is to say the back cushion 5 will not fix to the chair back 4, but it is lifted or inclined backwards with the chair back 4. Therefore although the back cushion 5 is closely in contact with the back a2, if the chair back 4 tilts backward, the back cushion 5 will slide down. On the contrary, the chair back 4 will rise and the back cushion 5 rises. Thus, the back a2 is always in contact with the back cushion 5 without any friction.

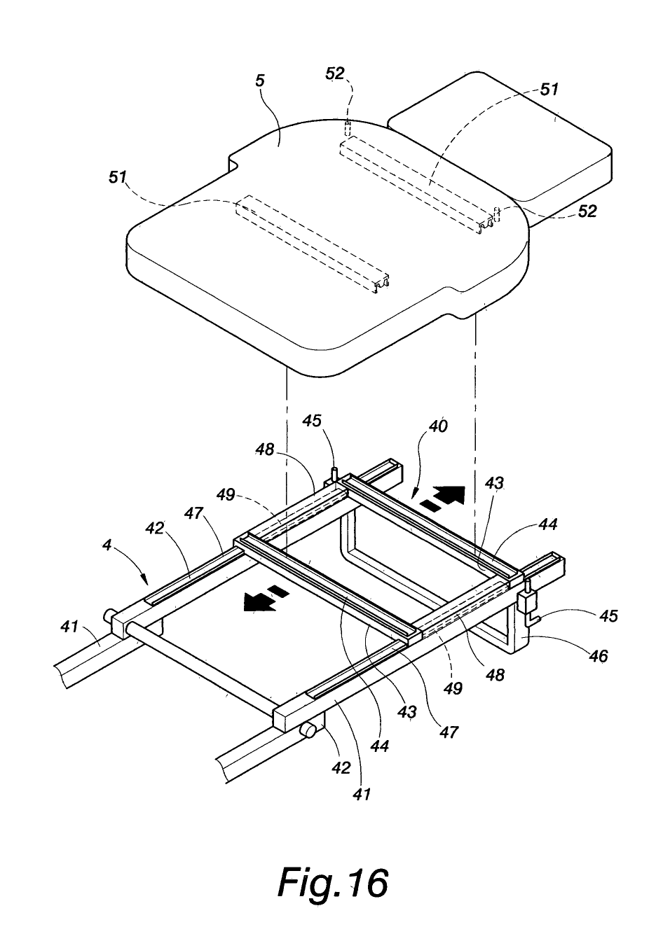

To make the back cushion 5 have longitudinally sliding effect, as shown in FIG. 16, in the present invention, the two lateral rods 41 of the chair back 4 are installed with sliding tracks 47. Furthermore, a set of sliding frame 40 is installed, which is formed by two lateral rods 48, and a plurality of transversal rods 43 which are combined to the two lateral rods 41. A connecting rod 49 is installed below the lateral rod 48 to be used with the sliding track 47. Thus, the sliding frame 40 has the function of longitudinally sliding by the actions of the connecting track 49 and the sliding track 47. Thus, the back cushion 5 can displace longitudinally on the chair back 4 through the sliding frame 40. The transversal rod 43 of the sliding frame 40 is installed with a sliding track 44. A connecting track 51 matching to the sliding track 44 is installed below the back cushion 5. Thus, the back cushion 5 can slide transversally. Thus, the back cushion 5 of the present invention has the functions of longitudinal and transversal movement. Besides, in the present invention, the back cushion 5 can have only the function of longitudinal movement without function of transversal movement. Namely, only the connecting tracks 49 matching to the two longitudinal sliding tracks 47 are installed below the back cushion 5 without installing sliding frames 40. Thereby, the back cushion 5 only moves longitudinally without function of transversal movement.

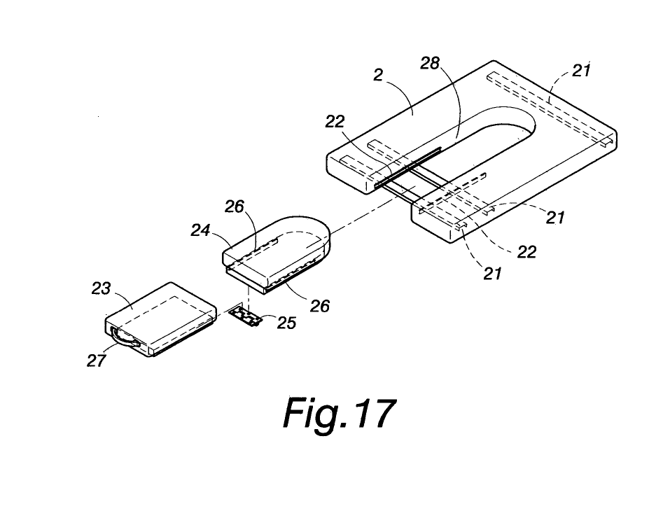

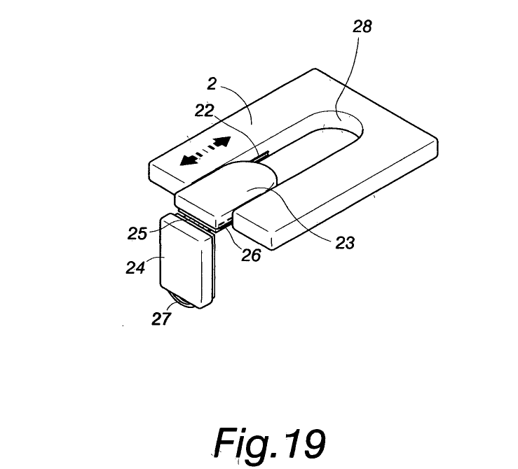

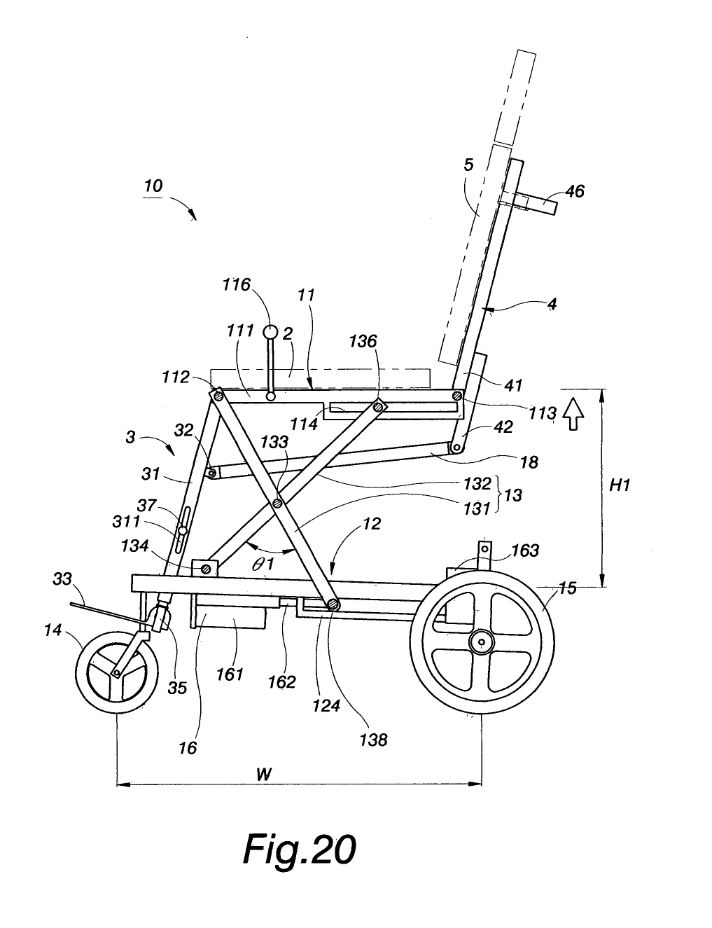

As shown in FIG. 17, the exploded view of the wheelchair of the present invention is illustrated. The body of the seat 2 has a groove 28. An opening of the groove 28 faces forwards and thus the seat body has a U shape. The groove 28 can receive a front and a rear sliding pads, i.e., a first sliding pad 23 and a second sliding pad 24. A hinge 25 serves to connect the two sliding pads 23 and 24. Two lateral walls of the groove 28 are installed with sliding tracks 22. Two sides of the second sliding pad 24 are installed with connecting tracks 26 which matches to the sliding tracks 22. Normally, the first and second sliding pads 23, 25 transversally moves to the groove 28 so that the groove is filled, as the chair cushion shown in FIGS. 2 and 11. When the patient desires to sit upon a stool, it is only necessary to move the wheelchair 10 backward so that the stool is positioned in the seat 1, as shown in FIG. 18 so that the seat 2 is positioned above the stool. Then the medial person holds the handle 27 in front of the first sliding pad 23 to pull the handle 27 outwards so that it can be pull out with the second sliding pad 24 (referring to FIG. 19) until the first sliding pad 23 faces downwards and the second sliding pad 24 is positioned before the opening of the groove. Then the displacement is stop. Then, a center of the chair cushion 2 is formed with a long opening so that the excretory organs of the patient are exactly above the opening. At this moment, the first sliding pad swings downwards. Since the stool is at a center position, the feet of the patient can place conveniently. If it is desired to return the wheelchair 10 to the original position, the second sliding pad 24 is moved transversally to the original position. Then the first sliding pad 23 is moved transversally so that the operation can be performed rapidly and conveniently.

Besides, the FIGS. 1 to 6 shows that the two sides of the chair cushion 2 of the seat 1 are installed with respective stop rods 116. The stop rods 116 are installed at a lateral side of the upper frame bars 111 for preventing the chair cushion 2 from vibrating forwards rightwards. Besides, the left and right armrests 6 serve to stop the chair cushion 2. Then the armrests 6 move downwards, and two hands of the user rest upon the armrests 6, the stop rods 116 serve to prevent the chair cushion 2 from movement.

### Second Embodiment

Referring to FIG. 10, in the drawing, rear ends of the primary rods 121 of the lower frame 12 are combined to the rear wheels 15 without any secondary rod 122. A parallel sliding frame 124 is installed below the primary rods 121 to be formed as a long track. Furthermore, a lower end of the first linkage 131 of the supporting frame 13 is installed with a sliding rod 138 (which can be further connected to rollers (not shown)). The sliding rod 138 can be confined to the track of the sliding frame 124. Next, a lower end of the primary rod 121 is combined to the push-and-brake device 16. An end portion of the telescopic rod 161 of the push-and-brake device 16 and the first linkage 131 use the same sliding rod 138. When the telescopic rod 161 reduces inwards, the first linkage 131 can be pushed directly. Then, by the first linkage 131 and second linkage 132 to change the angle, the pivotal shafts 112 and the sliding rod 136 at the tops of the first and second linkages will push the upper frame 11 to rise or descends stably. Advantage of this design is that the lower frame 12 is no longer a telescopic rod. When the seat 1 rises or descends, the width W between the front and rear wheels 14, 15 is not changed. Only the supporting frame 13 will change the height of the upper frame 11 by the telescopic movement of the push-and-brake device 16. Thus the base of the wheelchair 10 rises stably. Security of the present invention is increased.

### Third Embodiment

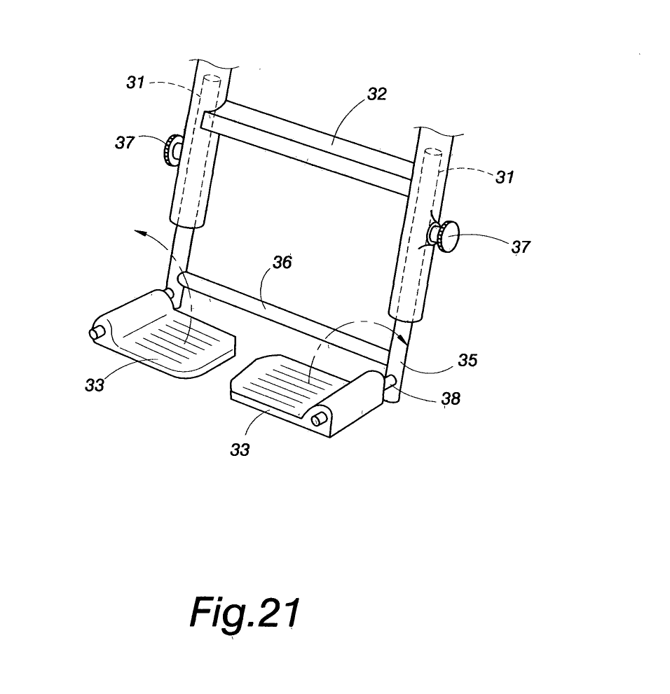

Referring to FIG. 21, the difference from the above embodiments is that in the footrest 3, the two treadles 33 are pivotally installed to the protruding rods 38 of the secondary rod 35 instead of installing on the lower transversal rod 36. Lower ends of two lateral rods 31 have no long holes. Then positioning screws 37 can be screwed into the secondary rods 35 of the lateral rods 31.

Effect of the present invention will be described herein. The height of the seat 1 is adjustable so that the user can take objects at different elevation. The wheelchair can be moved near a table surface and the higher of the seat is descendable to be at a height the same as a bed. The orientations of the chair back 4 and the footrest 3 are adjustable synchronously as necessary so that the user can lie flatly or seat on the wheelchair 10. The back cushion 5 can slide longitudinally. When the orientation of the chair back 4 is adjusted, the back cushion 5 can slide with the patient so as to prevent the ache of the back of the patient. When the patient sits from a lying pose, the push forward force from the chair back 4 can be reduced. The chair cushion 2 and back cushion 5 can slide transversally so that the medical person can move the patient to a bed from the wheelchair 10 or to the wheelchair 10 from a bed. When the wheelchair 10 rises or descends, the seat 1 rises or descends integrally, armrests 6 are placed at two sides of the wheelchair 10 for stopping the users so that the patient is prevented from turning to lateral side. Thus the security is increased. The armrests 6 and stop rods 116 can pivotally move. Thus the chair cushion 2 can move in or out transversally. A lower side of the chair cushion 2 is hollowed so that the wheelchair 10 can move backward to be above a stool so that the stool can be placed in the wheelchair 10. The structure of the wheelchair 10 is not deformable and can suffer from a heavy object. The groove of the chair cushion 2 are received with the first and second sliding pads 23, 24. As the two sliding pads 23, 24 are pulled out, the first sliding pad can move pivotally and downwards so as not to affect the movement of the legs. After the second sliding pad moves out, an opening is formed at a center of the body. When the stool moves backwards to be above the stool, the opening is above the stool so that the user can excrete easily. The treadles of the footrest 3 are telescopically so that when the patients lie flatly from sitting, the legs of the patient can stretch out comfortably. The treadle can be descended to the ground so that the legs of the patient can move transversally to the treadle. The legs are unnecessary to lift. A front and rear end of the upper frame 11 of the seat may have transversal pivotal rods and a front end of the lower frame 12 may have transversal rods. Under auxiliary three telescopic rods, the wheelchair 10 can be used with a stool and may support a heavy object so that it is not affect by gravitational force and is not deformable.

Above said components can be realized to the wheelchair 10 combinationally. For example, the chair back 4 and the footrest 3 can be combined so that the user can lie or sit on the wheelchair. In the process, the back cushion 5 can move longitudinally so that the back of the patient is not rub. After lie on the wheelchair 10, the height is adjustable so as to have the same level with the bed surface so that the patient can move transversally with the assistance of the chair cushion 2 and the back cushion 5.

What is claimed is:

1. A wheelchair comprising a seat (1), a chair cushion (2) covering on the seat (1), a footrest (3) in front of the seat (1), a chair back (4) at the back side of the seat (1), a back cushion (5) covering on the chair back (4), two armrests (6) at two sides of the seat (1), and two front wheels (14) and two rear wheels (15) below the seat (1);
the seat (1) being formed by an upper frame (11), a lower frame (12) and a supporting frame (13) installed between the upper frame (11) and the lower frame (12);
the upper frame (11) being formed by a left and a left bars (111), a front and a rear pivotal shafts (112), (113); and a sliding frame (114) being parallel to and below the bars (111) so as to long track groove is formed along the sliding frame (114);
the lower frame (12) having two primary rods (121); two secondary rods (122) telescopically moving in the respective primary rods (121) and a front transversal rod (123) connected between the two primary rods (121); front ends of the primary rods (121) being connected to the front wheels and rear ends of the secondary rods (122) being connected to the rear wheels; two push-and-brake device (16) being firmly secured to the lower frame (12); each push-and-brake device (16) having a telescopic rod (161); an end portion of the telescopic rod (161) being combined to the secondary rods (122) of the lower frame (12);
each supporting frame (13) including two sets of cross linkages; one set of the crossing linkages including one first push rod (131), one second push rod (132) and a pivotal shaft (133) for pivotally connecting the two push rods; a lower end of the first push rod (131) being pivotally connected to the secondary rod (122) by using a pivotal shaft (134) to connect the two; and the second push rod (132) being pivotally connected to the primary rod (121) by using a pivotal shaft (135) to combine the two so that the two push rods cross to one another; a top end of the first push rod (131), the upper frame bar (111) and the lateral frame (31) of the footrest (3) using the same pivotal shaft (112); a sliding rod (136) transversally installed at the top of the first push rod (131) being confined by the track groove of a sliding frame (114) of the upper frame bar (111);
wherein each of the armrest (6) is installed with a control device (8) so that when the telescopic rods (161) of the push-and-brake devices (16) telescopically move, the secondary rods in the primary rods (121) also telescopically moves so that the angle between the first linkage (131) and the second linkage (132) change; thus the seat (1) rises or descends.

2. A wheelchair comprising a seat (1), a chair cushion (2) covering on the seat (1), a footrest (3) in front of the seat (1), a chair back (4) at the back side of the seat (1), a back cushion (5) covering on the chair back (4), two armrests (6) at two sides of the seat (1), and two front wheels (14) and two rear wheels (15) below the seat (1);
the seat (1) being formed by an upper frame (11), a lower frame (12) and a supporting frame (13) installed between the upper frame (11) and the lower frame (12);
the upper frame (11) being formed by a left and a left bars (111), a front and a rear pivotal shafts (112), (113); and a sliding frame (114) being parallel to and below the bars (111) so that long track groove is formed along the sliding frame (114);
the lower frame (12) having two primary rods (121) and a front transversal rod (123) connected between the two primary rods (121); front ends of the primary rods (121) being connected to the front wheels and rear ends of the primary rods (121) being connected to the rear wheels; a sliding frame (124) being installed below the lower frame (12) so as to be formed as a long track groove; two push-and-brake device (16) being firmly secured to the lower frame (12); each push-and-brake device (16) having a telescopic rod (161);
each supporting frame (13) including two set of cross linkages; one set of the crossing linkage including one first push rod (131), one second push rod (132) and a pivotal shaft (133) for pivotally connecting the two push rods; a lower end of the first push rod (131) being pivotally connected to the secondary rod (122) by using a pivotal shaft (134) to connect the two; a lower end of the first push rod (131) and the telescopic rod (161) of the push-and-brake device (16) using the same sliding rod (138); the sliding rod (138) being confined in the long track groove of the sliding frame (124) of the primary rods (121); a top of the second push rod (132) being transversally installed with a sliding rod (136) and being confined in the sliding frame (114) below the upper frame bar (111) and a lower end of the second push rod (132) being combined to the primary rod (121) by a pivotal shaft (134);
wherein when the telescopic rods (161) of the push-and-brake devices (16) telescopically move, the angle between the first linkage (131) and the second linkage (132) will change; and thus the seat (1) rises or descends.

3. A wheelchair comprising a seat (1), a chair cushion (2) covering on the seat (1), a footrest (3) in front of the seat (1, a chair back (4) at the back side of the seat (1), a back cushion (5) covering on the chair back (4, two armrests (6) at two sides of the seat (1), and two front wheels (14) and two rear wheels (15) below the seat (1);
wherein the chair back (4) is formed by a left and a right lateral rods (41), a bottom of each lateral rod (41) extends with a supporting rod (42); the supporting rod (42) is an extending rod of the lateral rod (41); one supporting rod (42) is connected to an end portion of one telescopic rod (171) of a push-and-brake device (17); a base of the push-and-brake device (17) is fixed below the upper frame bar (111); thus push-and-brake device (17) is inclined; another supporting rod (42) is pivotally connected to one end of a linkage (18); another end of the linkage (18) is pivotally connected to the footrest lateral rod (32); by the push-and-brake device (17) to push the chair back (4) and the linkage (18) to drive the chair back (4) and the footrest (3) so that the chair back (4) and the footrest (3) can interact synchronously and the orientation of the chair back (4) is adjustable.

4. The wheelchair as claimed in claim 3, wherein the footrest (3) is formed by two lateral rods (31), two upper transversal rods (32) connected to the two lateral rods (31), two secondary rods (35) installed in the two secondary rods (35), two lower transversal rods (36) connected to the two secondary rods (35), two positioning screws (37) for fixing the secondary rods (35), and two treadles (33) installed below the secondary rods (35); a foot pad (34) is installed between the two lateral rods (31) for supporting the feet.

5. The wheelchair as claimed in claim 3, wherein the footrest (3) is formed by two lateral rods (31), two upper transversal rods (32) connected to the two lateral rods (31), two secondary rods (35) installed in the two secondary rods (35), two lower transversal rods (36) connected to the two secondary rods (35), two treadles (33) are pivotally installed to the protruding rods (38) of the secondary rod (35); and two positioning screws (37) are screwed into the secondary rods (35) of the lateral rods (31).

6. The wheelchair as claimed in claim 1, wherein a plurality of transversal rods are installed between the two upper frame bars (111); each transversal rod is formed with a sliding track; a bottom of the seat is installed with a connecting track matching to the sliding tracks so that the chair cushion (2) moves transversally; two stop rods (116) are installed on the two upper frame bars (111) for stopping the transversal movement of the chair cushion (2).

7. The wheelchair as claimed in claims 1, wherein a side of the upper frame bar (111) is fixed to the base (60); the base (60) is fixed to one side of a hinge (62)a and another side of the hinge (62)a is combined to the armrest (6); each armrest (6) is installed with a positioning stud (61); the positioning stud (61) is serially disposed with a spring (63); when the armrest (6) stands, the positioning stud (61) will insert into a positioning hole (601) of the base (60) by the resilient force of the spring (63).

8. A wheelchair comprising a seat (1), a chair cushion (2) covering on the seat (1), a footrest (3) in front of the seat (1), a chair back (4) at the back side of the seat (1), a back cushion (5) covering on the chair back (4), two armrests (6) at two sides of the seat (1), and two front wheels (14) and two rear wheels (15) below the seat (1);
the two lateral rods (41) of the chair back (4) are installed with longitudinal sliding tracks (47); a set of sliding frame (40) is installed, which is formed by two lateral rods (48, and a plurality of transversal rods (43) which are combined to the two lateral rods (41); a connecting rod (49) is installed below the lateral rod (48) to be used with the sliding track (47); thus, the sliding frame (40 has the function of longitudinally sliding by the actions of the connecting track (49) and the sliding track (47).

9. The wheelchair as claimed in claim 8, wherein each transversal rod (43) of the back cushion (5) is installed with transversal sliding track (44) and a bottom of the back cushion (5) is installed with connecting tracks (51) corresponding to the sliding tracks (44); and thus the back cushion (5) is movable transversally.

10. The wheelchair as claimed in claim 8, wherein the chair back (4) is installed with an elastic positioning stud (45); a bottom of the back cushion (5) is formed with insertion holes (52) for being inserted by the positioning studs (45).

11. A wheelchair comprising a seat (1), a chair cushion (2) covering on the seat (1), a footrest (3) in front of the seat (1), a chair back (4) at the back side of the seat (1), a back cushion (5) covering on the chair back (4), two armrests (6) at two sides of the seat (1), and two front wheels (14) and two rear wheels (15) below the seat (1);
a body of the seat (2) has a groove (28); an opening of the groove (28) faces forwards and thus the seat body has a U shape; the groove (28) receives a front and a rear sliding pads, i.e., a first sliding pad (23) and a second sliding pad (24); a hinge (25) serves to connect the two sliding pads (23) and (24); two lateral walls of the groove (28) are installed with sliding tracks (22); two sides of the second sliding pad (24) are installed with connecting tracks (26) which matches to the sliding tracks (22); when the first sliding pad (23) moves outwards, the second sliding pad (24) moves therewith until the first sliding pad (23) pivotally moves downwards and the second sliding pad (24) slides to a position of the first sliding pad (23) so that a center of the seat (2) is formed with a long opening for excretion.

12. The wheelchair as claimed in claim 11, wherein a handle is installed in front of the first sliding pad (23).
